(19) United States
(12) Patent Application Publication
(10) Pub. No.: US 2026/0227625 A1
(43) Pub. Date: Aug. 6, 2026

(54) MAGNETICALLY REPLACEABLE LENS PROTECTOR

(71) Applicants: Wei Liu, Dongguan (CN); Guangming Chen, Shangcai (CN)

(72) Inventor: Wei Liu, Dongguan (CN)

(21) Appl. No.: 19/632,134

(22) Filed: Mar. 27, 2026

(30) Foreign Application Priority Data
May 6, 2025 (CN) 202520875354.4

(51) Int. Cl. G02B 27/00; G03B 17/56; G03B 30/00

(52) U.S. Cl. CPC G02B 27/0006; G03B 17/565; G03B 30/00; G03B 2217/002

(57) ABSTRACT

A magnetically replaceable lens protector is provided, relating to the technical field of lens protectors, including a fixing sheet configured to adhesively fix around a lens and a magnetic sheet magnetically attached to the fixing sheet; the magnetic sheet is formed with an annular boss corresponding to the lens; the annular boss is formed with an annular recess; and a lens film is adhesively fixed in the annular recess, corresponding to the lens. By means of magnetic adhesion, issues of difficult detachment and residual adhesive associated with conventional adhesive protectors are addressed. When replacing the magnetic sheet or the lens film, no adhesive remains around the phone camera lens, and there is no need to remove fragments laboriously, which greatly reduces the difficulty of replacement and the risk of damage to the lens.

### TECHNICAL FIELD

The present disclosure relates to the technical field of lens protectors, more particularly to a magnetically replaceable lens protector.

### BACKGROUND

With the continuous development of the mobile phone industry, the functions of mobile phone cameras have been continuously upgraded, gradually evolving from the initial simple low-pixel shooting to current sophisticated components featuring high-pixel, multiple lenses, complex shooting modes. To protect these important lens components, mobile phone lens protectors have emerged accordingly. For example, the patent with the publication number CN202221314102.7 has provided a mobile phone lens protector, comprising structures such as a lens protection layer and a tempered glass layer, which is designed for easy application and a reduced risk of incorrect application.

However, existing mobile phone lens protectors have many challenges in practical usage and replacement. On one hand, in terms of application manner, many protectors are directly adhered to the lens surface. For example, for products mentioned in the patent with the publication number of CN217265528U, if such application manner causes the protectors to break, the fragments can easily remain on the rear surface of the lens, which requires considerable time for removal during subsequent replacement. In addition, if air bubbles or displacement occur during the application process, adhesive residue can greatly increase the difficulty of operation during re-application or replacement. On the other hand, most existing lens protectors lack a design for easy removal. For conventional tempered-glass lens protectors, if users want to replace them, they can only pry them up laboriously from the edges with fingernails or other tools. This process can easily scratch the lens or damage the protector. In addition, although some protective case-type lens protection devices can provide certain protection for the lens, the replacement of a lens film often requires removal of the entire protective case, which is cumbersome and may damage the original sealing and stability of the protective case, bringing great inconvenience to users.

### SUMMARY

To address the above drawbacks, the present disclosure aims to provide a technical solution capable of solving the aforementioned problems.

A magnetically replaceable lens protector includes a fixing sheet configured to adhesively fix around a lens and a magnetic sheet magnetically attached to the fixing sheet; the magnetic sheet is formed with an annular boss corresponding to the lens; the annular boss is formed with an annular recess; and a lens film is adhesively fixed in the annular recess, corresponding to the lens.

Preferably, the fixing sheet is embedded with a plurality of first magnetic bodies, the first magnetic bodies being flush with a surface of the fixing sheet; the magnetic sheet is embedded with a plurality of second magnetic bodies corresponding to the first magnetic bodies, the second magnetic bodies being flush with a surface of the magnetic sheet; the fixing sheet and the magnetic sheet are magnetically coupled through the magnetic attraction between the first magnetic bodies and the second magnetic bodies; and the fixing sheet and the magnetic sheet are positioned through the alignment between the plurality of first magnetic bodies and the plurality of second magnetic bodies.

Preferably, the first magnetic bodies are made of a magnetic material, and the second magnetic bodies are made of a magnetically permeable material.

Preferably, the first magnetic bodies are made of a magnetically permeable material, and the second magnetic bodies are made of a magnetic material.

Preferably, the magnetic sheet includes a positioning frame extending downward from an edge thereof; and the positioning frame is configured to surround the fixing sheet, allowing positioning of the magnetic sheet and the fixing sheet through the positioning frame.

Preferably, the magnetic sheet is formed with a plurality of annular bosses, and each of the annular bosses is provided with a lens film, to enable simultaneous protection of a plurality of lenses.

Preferably, the annular boss includes an outer annular wall abutting against a side portion of the lens and an inner annular wall annularly formed on an inner side of the outer annular wall to abut against an end portion of the lens, and wherein the annular recess is formed on the inner annular wall.

Preferably, an adhesive ring is attached in the annular boss, and an edge of the lens film is adhered to the annular boss through the adhesive ring.

Preferably, an adhesive layer is attached to a back surface of the fixing sheet, and the fixing sheet is attached around the lens through the adhesive layer.

Compared to the existing technology, the present disclosure has the following beneficial effects.

By means of magnetic adhesion, issues of difficult detachment and residual adhesive associated with conventional adhesive protectors are addressed. When replacing the magnetic sheet or the lens film, no adhesive remains around the phone camera lens, and there is no need to remove fragments laboriously, which greatly reduces the difficulty of replacement and the risk of damage to the lens. In addition, the design of the annular boss and the annular recess allows accurate alignment of the lens film to the lens, ensuring a tight fit between the lens film and the lens, thereby enhancing the protection effect, reducing the possibilities of dust, water stain and the like entering the lens, and meanwhile ensuring the light transmission and clarity during shooting, thereby guaranteeing the shooting quality of the phone.

Additional aspects and advantages of the present disclosure will be partially presented in the following description, some of which will become apparent from the following description or learned through practice of the present disclosure.

### BRIEF DESCRIPTION OF THE DRAWINGS

For a better understanding of the technical solution in the embodiments of the present disclosure or in the prior art, accompanying drawings required to be used in the description of the embodiments or the prior art are simply illustrated below. Apparently, the accompanying drawings described below are some embodiments of the present disclosure merely. For the ordinary skill in the field, other accompanying drawings may be obtained according to these accompanying drawings without creative effort.

FIG. 1 is a structural view of the present disclosure.

FIG. 2 is an exploded structural view of the present disclosure.

FIG. 3 is a disassembly structural view of the present disclosure.

FIG. 4 is a partial sectional structural view of the present disclosure.

FIG. 5 is a structural view of FIG. 4 with a lens film disassembled.

Reference numbers and names in the drawings are illustrated as below:

10, fixing sheet; 11, first magnetic body; 12, adhesive layer; 20, magnetic sheet; 21, annular boss; 211, outer annular wall; 212, inner annular wall; 22, annular recess; 23, lens film; 24, second magnetic body; 25, positioning frame; 26, adhesive ring.

### DETAILED DESCRIPTION OF THE EMBODIMENTS

A clear and complete description is provided below for the technical solution in the embodiments of the present disclosure. Obviously, the embodiments described hereinafter are merely part embodiments of the present disclosure, rather than all of the embodiments. All other embodiments obtained by the ordinary skill in the art based on the embodiments in the present disclosure without creative work are intended to be included in the scope of protection of the present disclosure.

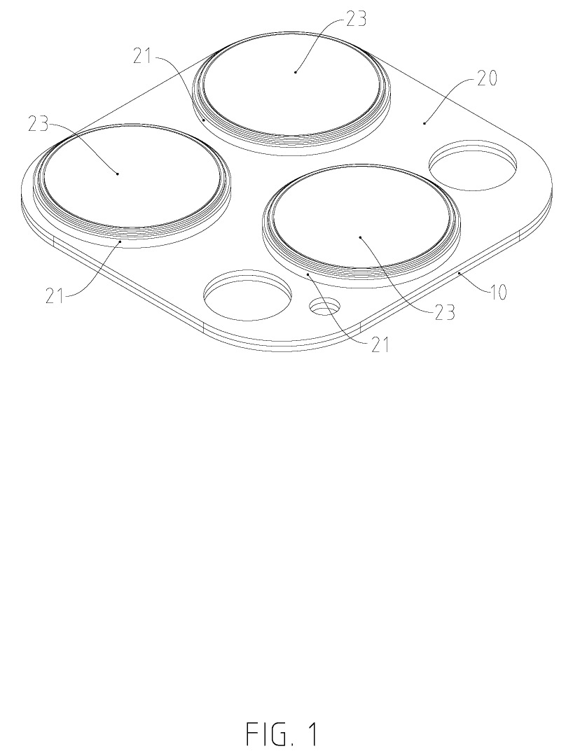

Referring to FIG. 1 to FIG. 5, in the embodiments of the present disclosure, a magnetically replaceable lens protector includes a fixing sheet 10 configured to adhesively fix around a lens and a magnetic sheet 20 magnetically attached to the fixing sheet 10; the magnetic sheet 20 is formed with an annular boss 21 corresponding to the lens; the annular boss 21 is formed with an annular recess 22; and a lens film 23 is adhesively fixed in the annular recess 22, corresponding to the lens.

The lens protector is composed of the fixing sheet 10 and the magnetic sheet 20. Before usage, the fixing sheet 10 is first firmly fixed around a phone camera lens by way of adhesion, to form a stable installation base. When it is needed to install the lens protector, just bring the magnetic sheet 20 close to the fixing sheet 10. Since there is a magnetic attraction between the magnetic sheet 20 and the fixing sheet 10, the magnetic sheet 20 can be accurately attached to the fixing sheet 10 autonomously, enabling quick installation. The annular boss 21 formed on the magnetic sheet 20 is adapted to the peripheral contour of the lens, and the lens film 23 adhered to the annular recess 22 can fit closely to the lens, forming an effective protection for the lens. When the lens film 23 needs to be replaced, simply apply an appropriate external force to overcome the magnetic attraction, whereby the magnetic sheet 20 can be easily separated from the fixing sheet 10 and subsequently the lens film 23 on the magnetic sheet 20 can be replaced. The whole process is simple and quick to operate.

In the above technical solution, by means of magnetic adhesion, issues of difficult detachment and residual adhesive associated with conventional adhesive protectors are addressed. When replacing the magnetic sheet 20 or the lens film 23, no adhesive remains around the phone camera lens, and there is no need to remove fragments laboriously, which greatly reduces the difficulty of replacement and the risk of damage to the lens. In addition, the design of the annular boss 21 and the annular recess 22 allows accurate alignment of the lens film 23 to the lens, ensuring a tight fit between the lens film 23 and the lens, thereby enhancing the protection effect, reducing the possibilities of dust, water stain and the like entering the lens, and meanwhile ensuring the light transmission and clarity during shooting, thereby guaranteeing the shooting quality of the phone.

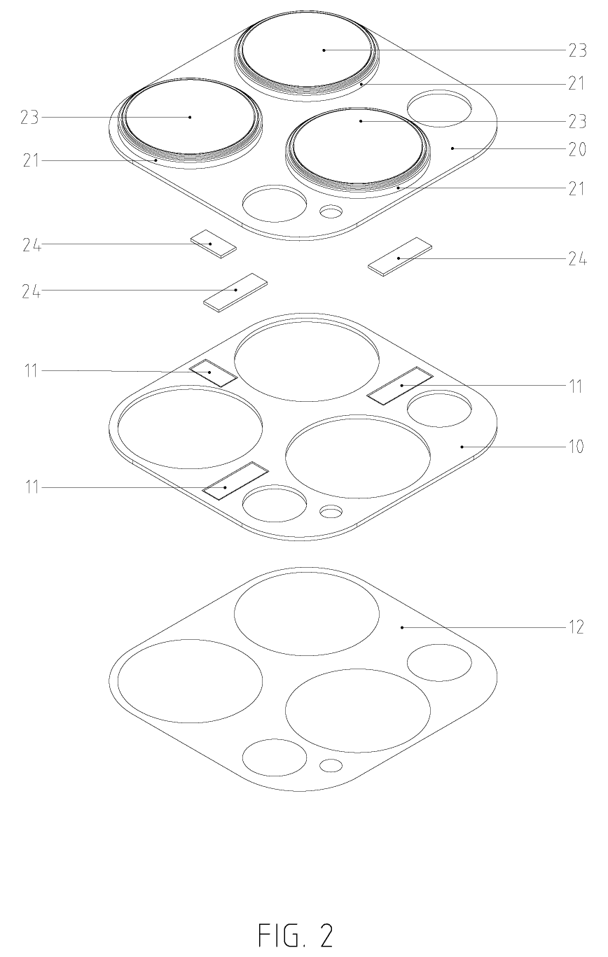

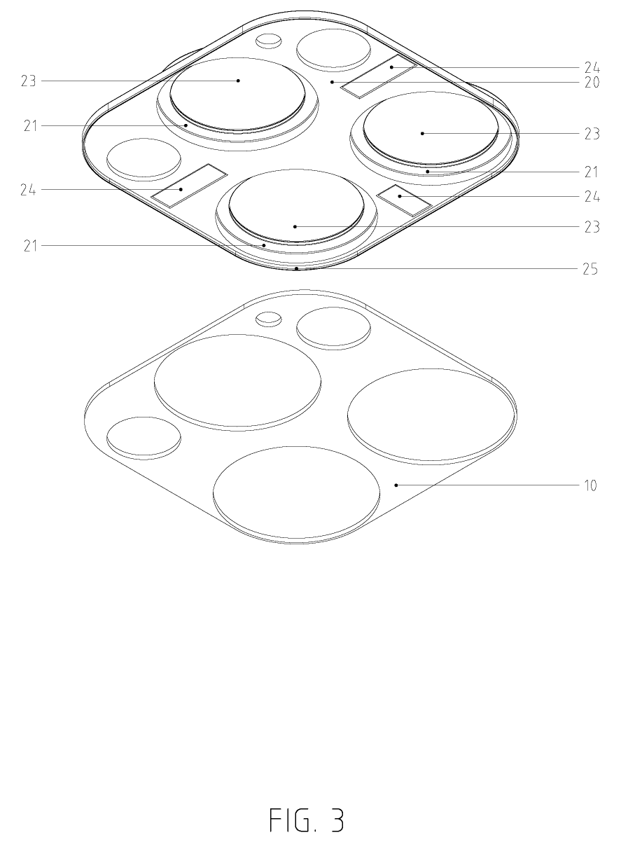

Referring to FIG. 2 to FIG. 3, on the basis of the above technical solution, the fixing sheet 10 is further embedded with a plurality of first magnetic bodies 11, the first magnetic bodies 11 being flush with a surface of the fixing sheet 10; and the magnetic sheet 20 is embedded with a plurality of second magnetic bodies 24 corresponding to the first magnetic bodies 11, the second magnetic bodies 24 being flush with a surface of the magnetic sheet 20. The fixing sheet 10 and the magnetic sheet 20 are magnetically coupled through the magnetic attraction between the first magnetic bodies 11 and the second magnetic bodies 24, meanwhile the fixing sheet 10 and the magnetic sheet 20 are positioned through the alignment between the plurality of first magnetic bodies 11 and the plurality of second magnetic bodies 24. By embedding the first magnetic bodies 11 and the second magnetic bodies 24 into the fixing sheet 10 and the magnetic sheet 20 respectively, and making surfaces thereof flush, on the one hand, the issue of poor fitting or abrasion due to protruding magnetic bodies is avoided, ensuring the flatness and aesthetic appearance of the overall structure. On the other hand, the arrangement of multiple sets of magnetic bodies not only enhances the magnetic coupling between the fixing sheet 10 and the magnetic sheet 20, making the lens protector less prone to detachment and enhancing the stability of protection, but also achieves accurate positioning by means of the corresponding positional relationship thereof, allowing the magnetic sheet 20 to quickly and accurately attach to the fixing sheet 10, thereby greatly simplifying installation steps and improving installation efficiency.

In the above technical solution, the first magnetic bodies 11 are made of a magnetic material, and the second magnetic bodies 24 are made of a magnetically permeable material. Alternatively, the first magnetic bodies 11 are made of a magnetically permeable material, and the second magnetic bodies 24 are made of a magnetic material. Different combinations of the magnetic material and the magnetically permeable material can reduce material cost and improve magnetic performance while satisfying the requirement of magnetic adhesion, achieving both economic efficiency and practicality of products.

Referring to FIG. 3 to FIG. 5, on the basis of the above technical solution, the magnetic sheet 20 further includes a positioning frame 25 extending downward from an edge thereof, and the positioning frame 25 is configured to surround the fixing sheet 10, allowing positioning of the magnetic sheet 20 and the fixing sheet 10 through the positioning frame 25. Through the cooperation between the positioning frame 25 and the fixing sheet 10, the positioning and installation accuracy of the lens protector can be further optimized, specifically, the positioning frame 25 can form a physical limit structure from the side, which, combined with the magnetic positioning between the magnetic bodies, achieves a three-dimensional accurate positioning effect. During installation, a user does not need to repeatedly adjust the position of the magnetic sheet 20, only needing to align the positioning frame 25 to the fixing sheet 10 to complete the quick and accurate installation of the magnetic sheet 20, greatly increasing installation efficiency. Meanwhile, such structure enhances the connection stability between the magnetic sheet 20 and the fixing sheet 10, effectively preventing the magnetic sheet 20 from horizontal displacement or offset during usage, ensuring that the lens film 23 accurately fits to the lens all the time, and further enhancing the protection effect for the phone camera lens.

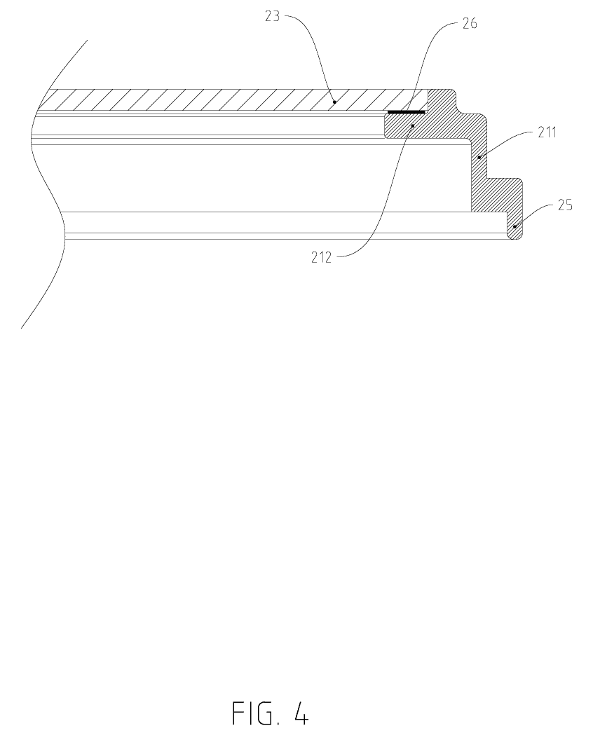

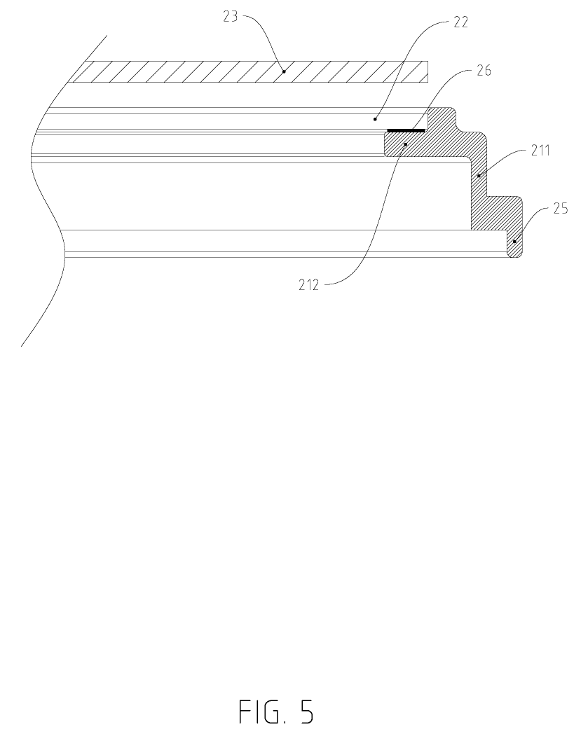

Referring to FIG. 4 to FIG. 5, on the basis of the above technical solution, to adapt to multi-lens phones, the magnetic sheet 20 is further formed with a plurality of annular bosses 21, and each of the annular bosses 21 is provided with a lens film 23, to enable simultaneous protection of a plurality of lenses. The annular boss 21 includes an outer annular wall 211 abutting against a side portion of the lens and an inner annular wall 212 annularly formed on an inner side of the outer annular wall 211 to abut against an end portion of the lens, and the annular recess 22 is formed on the inner annular wall 212, whereby the annular boss can stably abut against the side portion and end portion of the lens to form a tight protective boundary. Furthermore, the combination of the annular recess 22 and the inner annular wall 212 allows the lens film 23 to accurately fit to the surface of the lens. An adhesive ring 26 is attached in the annular boss 21, and an edge of the lens film 23 is adhered to the annular boss 21 through the adhesive ring 26, ensuring the flatness and stability of the lens film 23, preventing the edge lifting, peeling off and the like.

Referring to FIG. 2, on the basis of the above technical solution, an adhesive layer 12 is attached to a back surface of the fixing sheet 10, and the fixing sheet 10 is attached around the lens through the adhesive layer 12, ensuring that the fixing sheet 10 is firmly attached around the lens. The adhesive layer 12 is made of an OCA adhesive or a silicone material, avoiding adhesive residue and ensuring stable installation of the protector.

For those skilled in the art, it is apparent that the present disclosure is not limited to the details of the exemplary embodiments described above, and can be implemented in other specific forms without departing from the spirit or essential characteristics of the present disclosure. Therefore, no matter from which point, the embodiments should be viewed as exemplary, and not restrictive. The scope of the present disclosure is limited by claims appended herein rather than the foregoing description, therefore, all changes falling within the implication and scope of equivalent elements of the claims are intended to be included in the present disclosure.

What is claimed is:

1. A magnetically replaceable lens protector, comprising a fixing sheet (10) configured to adhesively fix around a lens and a magnetic sheet (20) magnetically attached to the fixing sheet (10), the magnetic sheet (20) being formed with an annular boss (21) corresponding to the lens, the annular boss (21) being formed with an annular recess (22), and a lens film (23) being adhesively fixed in the annular recess (22), corresponding to the lens.

2. The magnetically replaceable lens protector according to claim 1, wherein the fixing sheet (10) is embedded with a plurality of first magnetic bodies (11), the first magnetic bodies (11) being flush with a surface of the fixing sheet (10); wherein the magnetic sheet (20) is embedded with a plurality of second magnetic bodies (24) corresponding to the first magnetic bodies (11), the second magnetic bodies (24) being flush with a surface of the magnetic sheet (20); wherein the fixing sheet (10) and the magnetic sheet (20) are magnetically coupled through the magnetic attraction between the first magnetic bodies (11) and the second magnetic bodies (24); and wherein the fixing sheet (10) and the magnetic sheet (20) are positioned through the alignment between the plurality of first magnetic bodies (11) and the plurality of second magnetic bodies (24).

3. The magnetically replaceable lens protector according to claim 2, wherein the first magnetic bodies (11) are made of a magnetic material, and wherein the second magnetic bodies (24) are made of a magnetically permeable material.

4. The magnetically replaceable lens protector according to claim 2, wherein the first magnetic bodies (11) are made of a magnetically permeable material, and wherein the second magnetic bodies (24) are made of a magnetic material.

5. The magnetically replaceable lens protector according to claim 1, wherein the magnetic sheet (20) comprises a positioning frame (25) extending downward from an edge thereof, the positioning frame (25) being configured to surround the fixing sheet (10), allowing positioning of the magnetic sheet (20) and the fixing sheet (10) through the positioning frame (25).

6. The magnetically replaceable lens protector according to claim 1, wherein the magnetic sheet (20) is formed with a plurality of annular bosses (21), each of the annular bosses (21) being provided with a lens film (23), to enable simultaneous protection of a plurality of lenses.

7. The magnetically replaceable lens protector according to claim 1, wherein the annular boss (21) comprises an outer annular wall (211) abutting against a side portion of the lens and an inner annular wall (212) annularly formed on an inner side of the outer annular wall (211) to abut against an end portion of the lens, and wherein the annular recess (22) is formed on the inner annular wall (212).

8. The magnetically replaceable lens protector according to claim 1, wherein an adhesive ring (26) is attached in the annular boss (21), and wherein an edge of the lens film (23) is adhered to the annular boss (21) through the adhesive ring (26).

9. The magnetically replaceable lens protector according to claim 1, wherein an adhesive layer (12) is attached to a back surface of the fixing sheet (10), and wherein the fixing sheet (10) is attached around the lens through the adhesive layer (12).
